(19) United States
(12) Patent Application Publication
(10) Pub. No.: US 2022/0380119 A1
(43) Pub. Date: Dec. 1, 2022

(54) Shelving Unit for a Shipping Container

(71) Applicant: Rebound International, LLC, Houston, TX (US)

(72) Inventors: David Jung, Houston, TX (US); Yongbo Zhang, Beijing (CN); Wei Wang, Beijing (CN); Frederico Chow, Sugar Land, TX (US)

(21) Appl. No.: 17/331,628

(22) Filed: May 26, 2021

Related U.S. Application Data
(63) Continuation of application No. 17/331,624, filed on May 26, 2021.

(51) Int. Cl. B65D 90/00; B65D 90/48; B65D 88/12; G06K 7/10

(52) U.S. Cl. CPC B65D 90/0073; B65D 90/48; B65D 88/121; B65D 90/008; G06K 7/10366

(57) ABSTRACT

An improved shelving unit for a shipping container is disclosed herein. The improved shelving unit can comprise one or more shelf assemblies and an RFID reader. Each of the one or more shelf assemblies can comprise a bottom platform and a top platform. The RFID reader can be mounted between the bottom platform and the top platform. The top platform can be capable of supporting items.

### BACKGROUND

This disclosure relates to an improved wall panel for an automated inventory module (AIM). This disclosure also relates to an improved shelving unit for a shelving container. This disclosure further relates to an automated inventory system and method.

Non-productive time (NPT) affects many industries, and the current MRO supply chain is a part of that problem. To protect against downtime, work sites such as drilling rigs often keep consumable parts in one or more local storage areas such as consignment boxes and in one or more regional warehouses. However, consignment boxes do not adequately protect against unplanned downtime. Moreover, problems such as supply levels in consignment box are still unknown by the drilling company, and theft can be rampant. Additionally, there can be discrepancies in inventory that can lead to unhappy relationships between vendors and consumers. Lastly, soft costs are expended in accounting processes related to the consignment boxes. This only shows that consignment boxes do not solve the problem of non-productive time. Regional warehouses by themselves do not solve the problem as well since regional warehouses can be hours away from the site, it can add to the non-productive time problem of the industry. Moreover, significant manpower can be required to keep track of inventory of regional warehouses. Another problem that can be usually encountered are human errors such as incorrect inventory counts. Furthermore, as seen in the figure the supply chains are not connected and can be using separate platforms when monitoring and managing their inventories. As such, it would be useful to have an improved system and method for automating inventory processes within local storage areas.

Standard shipping containers can be used as local storage areas. Shipping containers can be built with corrugated steel walls, which are designed to provide strength to the structure without significantly increasing the weight of the container. Such design makes the shipping container a viable structure for transporting, storing, and securing different products that are used for different purposes. One of the practical uses for shipping container can be providing a mobile MRO (maintenance, repair, and operating supplies) solution for drilling rig sites or other industrial sites or sites with industrial components or commercial inventory. In such system, the shipping container can be used for storing and securing purchasable products. As such, shipping container can be customized to work with a smart control system that can work with RFID (radio frequency identification) technology to manage and maintain the operating supplies within a specific site. However, the corrugated wall structure of the shipping container can cause electromagnetic signals from RFID to disperse. Such interference can significantly affect the ability of RFID readers to read RFID tags placed on the purchasable products. As such it would be useful to have an improved wall panel for an automated inventory system.

Furthermore, storing different products within the shipping container such that products can be displayed and organized for easier access and tracking can be important in order to provide an effective mobile MRO solution for different industrial and commercial sites. However, available shelving solutions make reading RFID tags by RFID readers in a container difficult. As such, it would be useful to have an improved shelving unit for a shipping container.

### SUMMARY

This disclosure relates to an improved wall panel for an automated inventory module. The improved wall panel can comprise a wall panel. The wall panel can be capable of being mounted at a corrugated interior surface of an automated inventory module (AIM). The wall panel can comprise a substantially flat first exterior layer comprising a first side and a second side. The first exterior layer first side can face the interior of the AIM when the wall panel is mounted at the interior surface, and the first exterior layer second side can face the interior surface when the wall panel is mounted at the interior surface. The first exterior layer can comprise a ferromagnetic material.

Additionally, a system for improving RFID reading with AIM is disclosed herein. The system can comprise a door assembly, a wall panel, and a plurality of L-shaped frames. The wall panel can comprise a door assembly, a substantially flat first exterior layer, a middle layer, and a second exterior. The first exterior layer can comprise a first side and a second side. The first exterior layer first side can face an interior of a shipping container when the door assembly is mounted to an AIM and in a closed position. The middle layer can be adjacent to the first exterior layer second side. The middle layer can comprise an insulation material. The second exterior can be adjacent to the middle layer such that the middle layer is between the first exterior layer and the second exterior layer. The second exterior layer can be mountable at an interior wall of the door assembly of the AIM. The plurality L-shaped frames can be placed around the sides of the wall panel. The L-shaped frames can be mounting the wall panel to the door assembly.

A system for improving electromagnetic signals within an AIM is disclosed herein. The system can comprise a first set of wall panels. Each wall panel of the first set of wall panels can be mountable at one of a plurality of interior surfaces of an AIM. Each wall panel of the first set of wall panels can comprise a substantially flat first exterior layer, a middle layer and a second exterior layer. The first exterior layer can comprise a first side and a second side. The first side can be facing an interior of the AIM when mounted to the one of a plurality of interior surfaces. The middle layer can be adjacent to the first exterior layer. The middle layer can comprise an insulation material. The second exterior layer can be adjacent to the middle layer such that the middle layer is placed in between the first exterior layer and the second exterior layer. The second exterior layer can be adjacent to the one of the plurality of interior surfaces of the AIM.

In another embodiment an improved shelving unit for a shipping container is disclosed herein. The improved shelving unit can comprise one or more shelf assemblies and an RFID reader. Each of the one or more shelf assemblies can comprise a bottom platform and a top platform. The RFID reader can be mounted between the bottom platform and the top platform. The top platform can be capable of supporting items.

An improved automated inventory system is also disclosed. The improved automated system (AIS) can comprise an enclosure for storing one or more items, one or more RFID readers, and a control system. Each of the items are tagged with an RFID (radio frequency identification) tag. The enclosure can comprise a plurality of a plurality of interior surfaces that defines an interior space within said enclosure. The enclosure can also comprise one or more access points within the interior surfaces that allow access to the items within the enclosure. Each of the RFID readers can be capable of reading the RFID tag. The control system can be in communication with the one or more RFID readers. The control system can detect when an item is placed within the enclosure, and can add the item to an inventory list associated with the enclosure when the RFID tag associated with the item is detected within the enclosure by any of the one or more RFID readers. The control system can also remove the item from the inventory list when the RFID tag associated with the item is no longer detected by any of the one or more RFID readers.

Additionally, a method of using an automated inventory system (AIS) is disclosed. The method can comprise detecting when an item is placed within an enclosure by a control system. The control system can be in communication with one or more RFID readers by detecting an RFID tag on the item. The enclosure can be for storing one or more items. Each of the items tagged an RFID (radio frequency identification) tag. The enclosure can comprise a plurality of interior surfaces that defines an interior space within the enclosure. Further one or more access points within the interior surfaces can allow access to the items to pass in and out of the enclosure. The control system can also add the item to an inventory list associated with the enclosure, when the RFID tag associated with the item is detected within the enclosure by any of the one or more RFID readers. Lastly, the control system can remove the item by the control system, from the inventory list when the RFID tag associated with the item is no longer detected by any of the one or more RFID readers.

### BRIEF DESCRIPTION OF THE DRAWINGS

FIG. 1A illustrates an embodiment of an automated-inventory module (AIM).

FIG. 1B illustrates an embodiment wherein enclosure is a shipping container.

FIG. 1C illustrates a front view of an embodiment of posterior doors.

FIG. 1D illustrates internal hardware within automated-inventory module.

FIG. 2A illustrates an embodiment of a panel.

FIG. 2B illustrates another embodiment of a panel.

FIG. 3A illustrates another embodiment of panel herein middle layer comprises a plurality of beams.

FIG. 3B illustrates another embodiment of panel only comprising first exterior layer.

FIG. 4A illustrates panel comprising a support frame.

FIG. 4B illustrates a side section view of panel comprising a support frame.

FIG. 5 illustrates enclosure 101 with panels covering a plurality of interior surfaces.

FIG. 6 illustrates an exploded view of panel attached to door.

FIG. 7 illustrates an embodiment of a shelving unit.

FIG. 8 illustrates a closer view of a bar comprising a plurality of slots, and a plurality of catches.

FIG. 9A illustrates an embodiment of a shelf assembly.

FIG. 9B illustrates how shelf assembly can attach to vertical bars.

FIG. 10 illustrates a shelf base comprising an RFID reader.

FIG. 11 illustrates an embodiment of a front guard at a locked position.

FIG. 12 illustrates an embodiment of front guard at an unlocked position.

FIG. 13 illustrates a supply chain and e-commerce platform

FIG. 14 illustrates an automated supply chain and e-commerce (ASCE) platform.

FIG. 15 illustrates an example embodiment of how a contractor can access one or more items from automated-inventory module.

FIG. 16 illustrates how items can be managed and monitored through ASCE platform.

FIG. 17 illustrates a dashboard main screen embodiment of supply system application.

FIG. 18A-18D illustrates screen embodiments of supply system application as viewed by contractor.

FIG. 19A-19C illustrates a screen embodiments of supply system application 1401 as viewed by vendors.

### DETAILED DESCRIPTION

This disclosure relates to an improved wall panel for an automated inventory module. This disclosure also relates to an improved shelving unit for a shelving container. This disclosure further relates to an automated inventory system and method. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

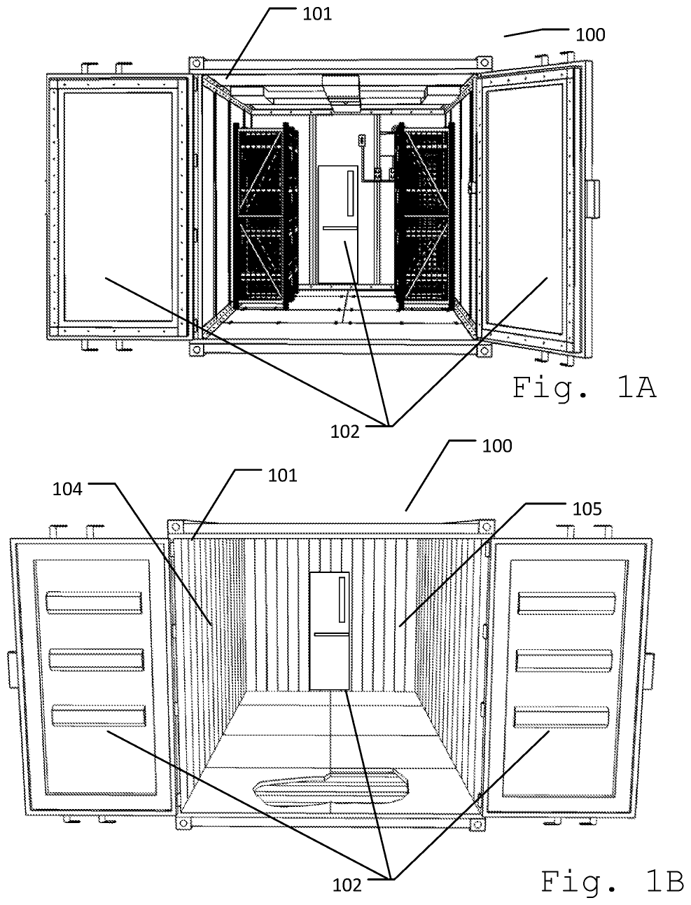

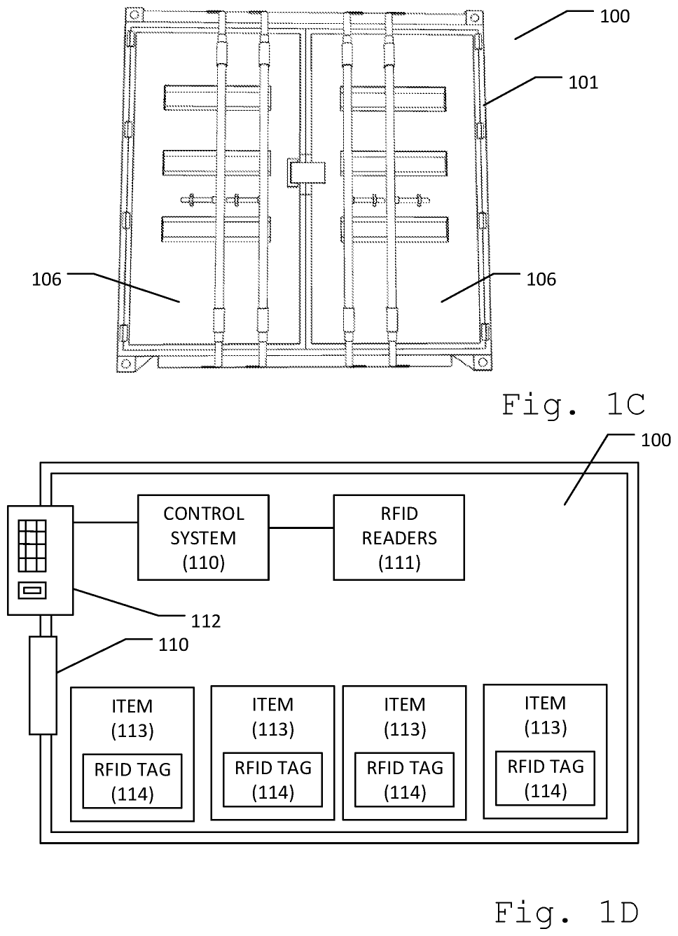

FIG. 1A illustrates an embodiment of an automated-inventory module (AIM) 100. AIM 100 can comprise an enclosure 101 for storing inventory. In a preferred embodiment, enclosure 101 can be mobile. Enclosure 101 can comprise one or more access points 102 such as a door. In one embodiment, enclosure 101 and access points 102 can be made of a durable material such as metal.

FIG. 1B illustrates an embodiment wherein enclosure 101 is a shipping container. A shipping container is a large reusable container that is designed to withstand shipment and storage of products within a transport system. Most often, shipping containers are made primarily of steel and are capable of storing and transporting items over various modes of transport including ship, rail, or truck. Shipping containers are typically generally in the shape of a rectangular prism. In a preferred, enclosure 101 can be large enough to allow one or more individuals to access and move around inside enclosure 101. Enclosure 101 can comprise interior surfaces 104 defined by structures such as walls, a floor, and a ceiling. Such structures can together define an interior space 105 within enclosure 101. Furthermore, surfaces 104 can be corrugated to provide strength and allow stacking of enclosures 101. Access points 102 can be placed within inner surfaces to allow inventory and individuals to move into and out of interior space 105.

In one embodiment, enclosure can comprise a frame a floor, a pair of sidewalls, a front-end wall, a ceiling, and a door assembly 106. Frame can provide structural support and connect the parts of shipping container together. In an example embodiment, frame can comprise a plurality of rails, a plurality of posts, and a door header. Rails can provide lateral structure for frame. Rails can comprise a pair of top side rails, a pair of bottom side rails, a top end rail and a bottom end rail. Posts can provide vertical support to the four corners of frame. Posts can connect each rail and door header together through a plurality of corner fittings. In such structure, each corner fitting can connect the eight corners of enclosure 101. Corner fittings can provide shipping container capability for stacking, handing and securing the containers. Door header can be the lateral structure placed at the top rear of enclosure 101 where door assembly 106 can be placed. In one embodiment, frame can further comprise a plurality of bottom cross members. Bottom cross members can be the lateral frame structures attached to bottom side rails. Bottom cross members can support floor of enclosure 101. In such embodiment, sidewalls are the interior surfaces covering the opposite sides of shipping container enclosure, and the front-end interior surface is interior surface opposite posterior doors. In one embodiment, a door can be built into front-end wall.

FIG. 1C illustrates a front view of an embodiment of posterior doors 106. In one embodiment, posterior doors 106 can comprise a pair of door panels 107, a plurality of handles 108, and a locking system 109. Door panels 107 can be vertical panels that form at the rear end portion of enclosure 101. Door panels 107 can provide access to interior space of enclosure 101. Handles 108 can be placed at the external surface of door panels 107. Handles 108 can serve as a grip to open door panels 107. Locking system 109 can be used to secure posterior doors 106.

FIG. 1D illustrates internal hardware within AIM 100. AIM 100 can comprise a control system 110, one or more RFID readers 111 in communication with control system 110, and an access control system 112. Inventory can include one or more items 113, each item having a radio frequency identification (RFID) tag 114. RFID tag 114 can comprise a unique identifier that can be read by RFID reader 111. RFID tag 114 can allow each item 113 to be identified and tracked by AIM control system 101. Furthermore, in one embodiment, RFID tag 114 can comprise information on items 113, such as component name, manufacturer, etc.

In one embodiment, access control system 112 can be a device, such as an electric lock, installed on access points 102. In such embodiment, access control system 112 can comprise of electronic reader, and/or a keypad that can allow an individual to enter an access key on control system 110 before granting access to items 113 within enclosure 101. For purposes of this disclosure, access key can be a keyed-in alphanumeric character, or a machine-readable code entered on AIM 100 through access control system 112.

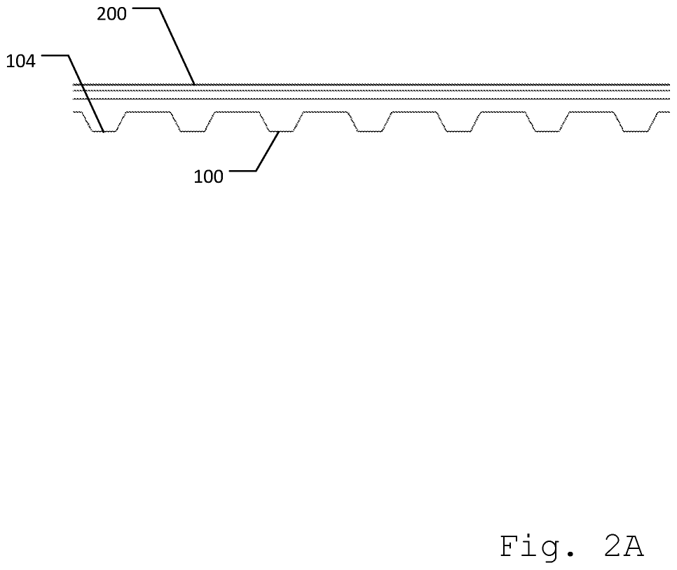

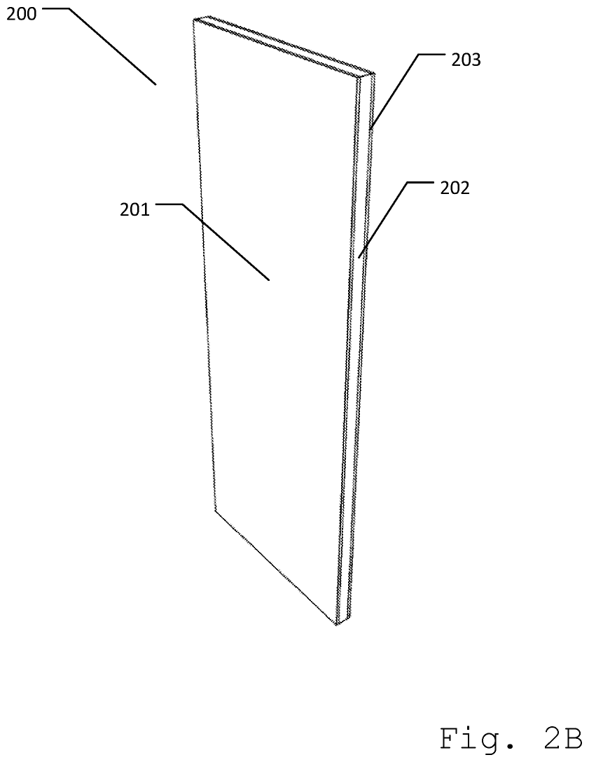

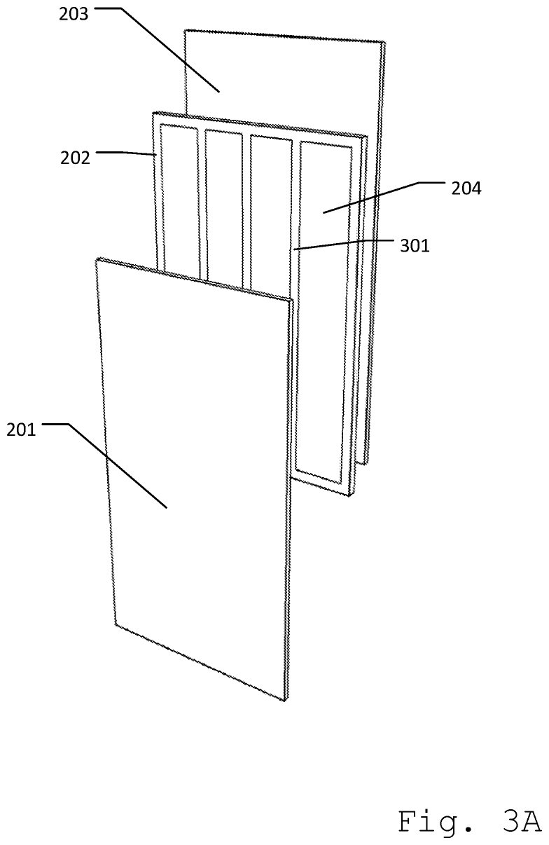

FIG. 2A illustrates an embodiment of a wall panel 200. Wall panel 200 can be installed on interior surfaces 104 of enclosure 101. In one embodiment, wall panel 200 can consist essentially of a flat metallic sheet material that is attachable to or mountable at an interior surface 104. In a preferred embodiment, such metallic sheet is aluminum or steel. In such embodiment, wall panel 200 can decrease the dispersion of RFID signals, thus providing a better transmission of electromagnetic signals within enclosure 101 between RFID tags 114 and RFID reader 111.

FIG. 2B illustrates another embodiment of wall panel 200. In one embodiment, panel 200 can comprise a substantially flat first exterior layer 201, a middle layer 202, and a second exterior layer 203. First exterior layer 201 can have a first side and a second side. First exterior layer 201 first side can face the middle of the interior space 104 of the shipping container. Middle layer 202 can also have a first side and a second side. Middle layer 202 first side can be adjacent first exterior layer 201, while Middle layer 202 second side can be adjacent second exterior layer 203. Second exterior layer 202 can have a first side and a second side. Second exterior layer 202 first side can face middle layer 202, while second exterior layer 202 second side can face interior surface of AIM 100, while second exterior layer 203 faces interior surface to which panel 200 is mounted. In one embodiment, first exterior layer 201 can be made of one or more metallic sheets such as aluminum or steel. In another embodiment, second exterior layer 203 can be made of one or more metallic sheets such as aluminum or steel. Middle layer 202 can be between first exterior layer 201 and second exterior layer 203. In one embodiment, middle layer 202 can comprise of an insulation material 204. Insulation material 204 can be any material that reduces or prevents transmission of heat, sound, or electricity. Some examples of insulation material 204 can include but is not limited to fiberglass insulation, slag wool, mineral wool, stone wool, polyurethane (PU) foam, etc. In a preferred embodiment, insulation material 204 can be a stone wool. In such embodiment, middle layer 202 can be sound absorbing and fire-resistant.

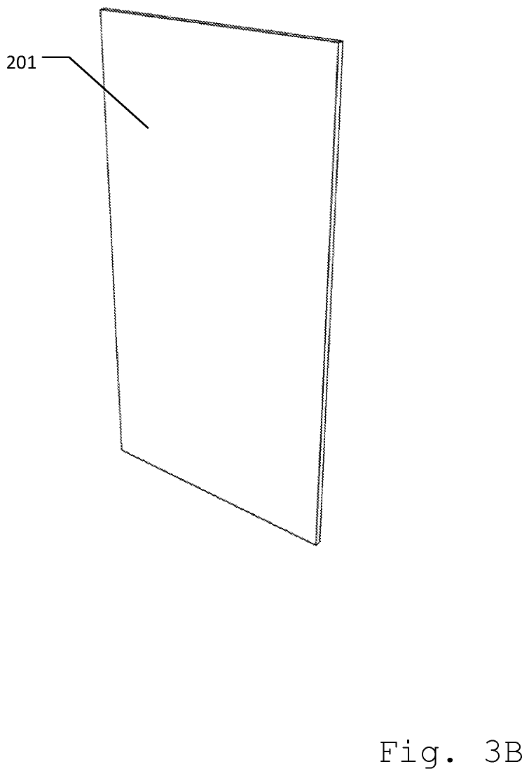

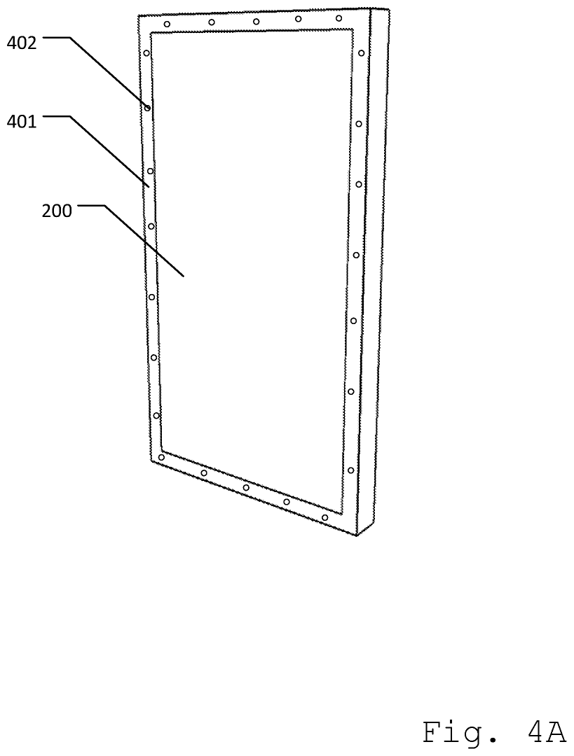

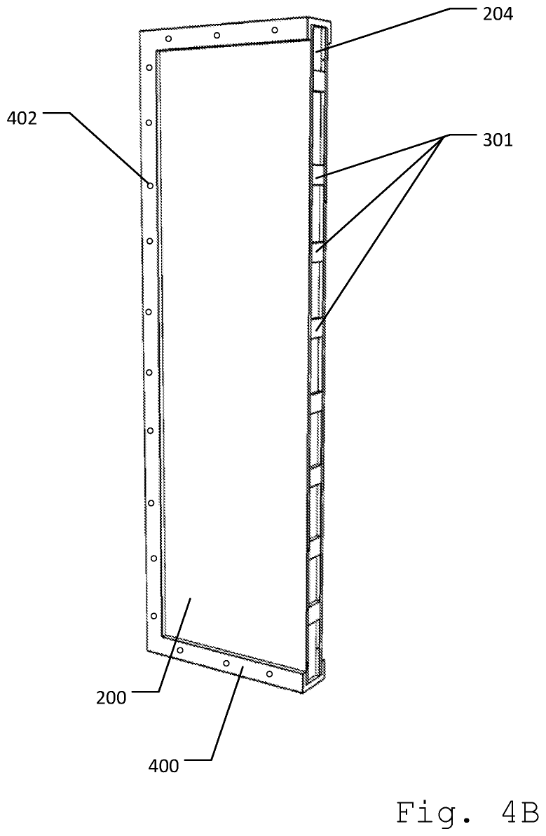

FIG. 3A illustrates another embodiment of panel 200 herein middle layer 202 comprises a plurality of beams 301. Beams 301 can provide framing and sturdy structure for panel 200. Beams 301 can be made of any durable material such as wood or metal. In this embodiment, beams 301 can be placed within middle layer 202. In one embodiment, beams 301 can be horizontal. In another embodiment, as shown in FIG. 3. In other embodiments, beams 301 can have a lateral structure. In such embodiment, insulation material 204 can be placed within the voids created between first exterior layer 201, second exterior layer 203, and beams 301.

FIG. 3B illustrates another embodiment of panel 200 only comprising first exterior layer 201. In this embodiment, only a flat metallic sheet material attached to the inner surface of enclosure 101.

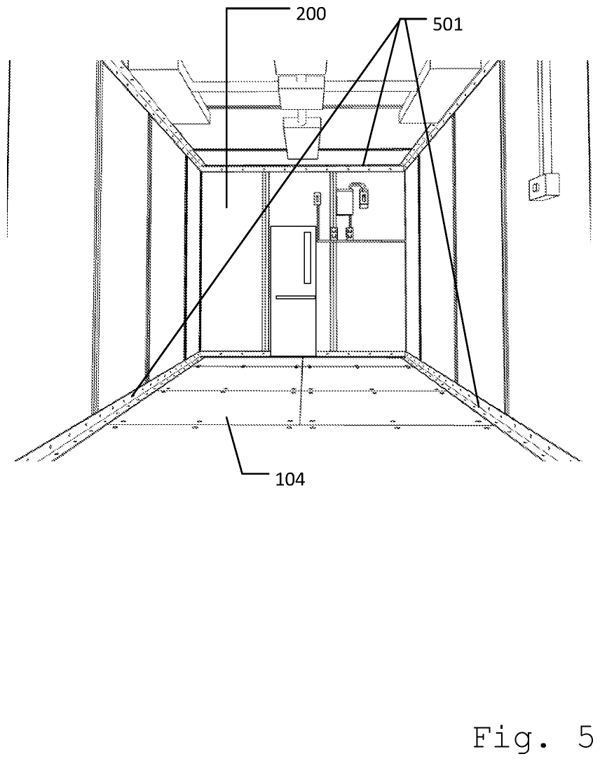

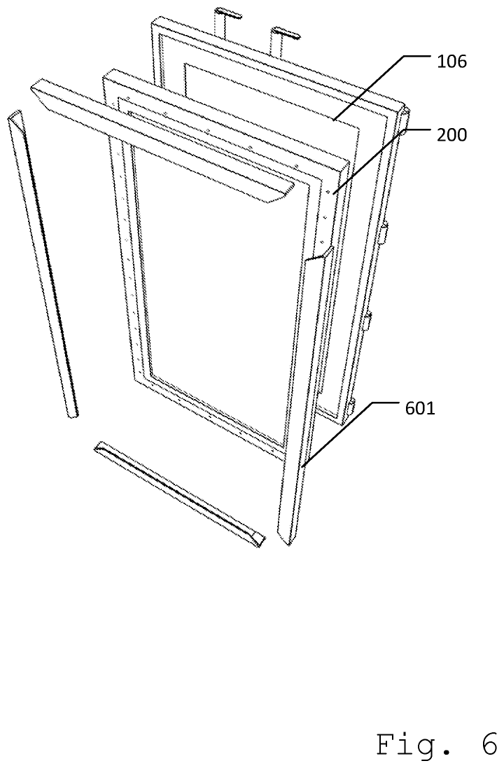

FIG. 4A illustrates panel 200 comprising a support frame 401. In one embodiment, support frame 401 can be a U-shaped frame that holds first exterior layer 201, second exterior layer 203, and middle layer 202 together. In such embodiment, support frame 401 can be wrapped around the outer ends of panel 200 exposing a large surface area of first exterior layer 201. Frame fasteners 402 such as rivets can connect support frame 401 to first exterior layer 201 and second exterior layer 203

FIG. 4B illustrates a side section view of panel 200 comprising support frame 401.

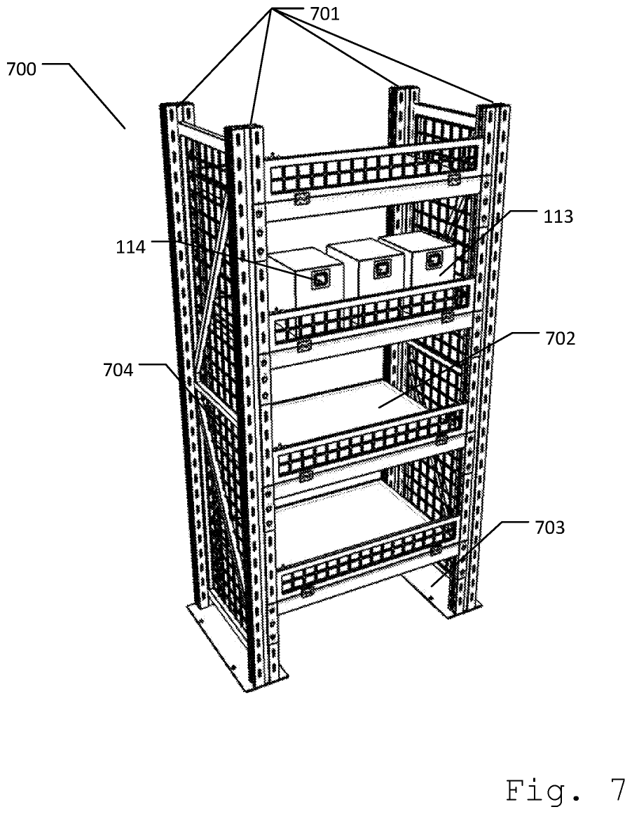

FIG. 5 illustrates enclosure 101 with panels 200 covering a plurality of interior surfaces 104. Interior surfaces can define the interior space within enclosure 101. In one embodiment, each interior surface can be substantially covered by one or more panels 200. In one embodiment wherein one panel 200 on one interior surface 104 meets another panel 200 on another interior surface or a floor, both such panels 200 or the one panel 200 and the floor can be connected to each other using an “L” bracket 501 and frame fasteners 402. “L” bracket 501 can be made of durable material such as steel or aluminum. Having an irregular wall surface can cause the signals within the container to be diffracted as electromagnetic waves can bend when an obstacle is encountered. Thus, the flat surface of each panel 200 can enhance the transmission of signals within the container since less diffraction will occur as compared to corrugated steel walls. In another embodiment, panels can be affixed using any method known in the art including but not limited to welding, cementing, gluing or fastening using fasteners. In one embodiment, panels 200 attached to floor 102 can be substantially flat, but textured for traction.

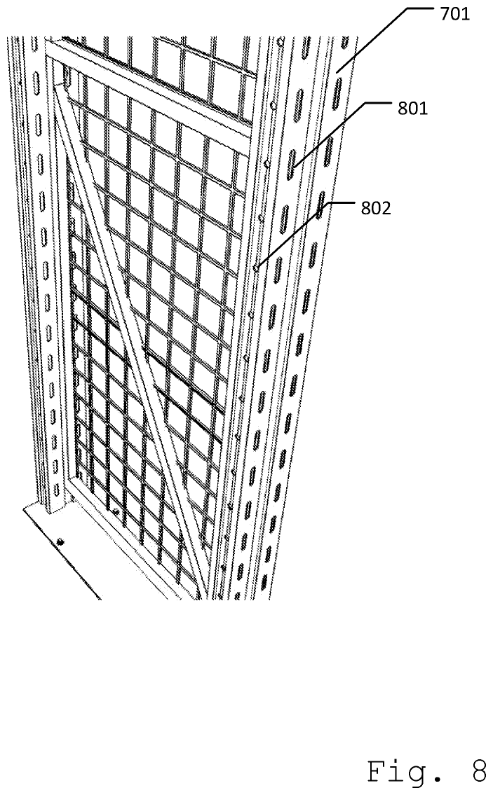

FIG. 6 illustrates an exploded view of panel 200 attached to door panel 107. In one embodiment, panel 200 can be mounted to the back surface of door panel 107 through L-shaped frame 601. In this embodiment, each L-shaped frame 601 can be welded to door panel 107. In such embodiment, each L-shaped frame 601 can be facing towards the wall panel direction, such that the horizontal beams of L-shaped frame 601 can attach to the outer front sides of panel 200 while the vertical beams of L-shaped frame 601 can rest around the sides of panel 200. In such structure, the outer edges of the vertical beams of L-shaped frame 501 can be welded to the back surface of door panel 107.

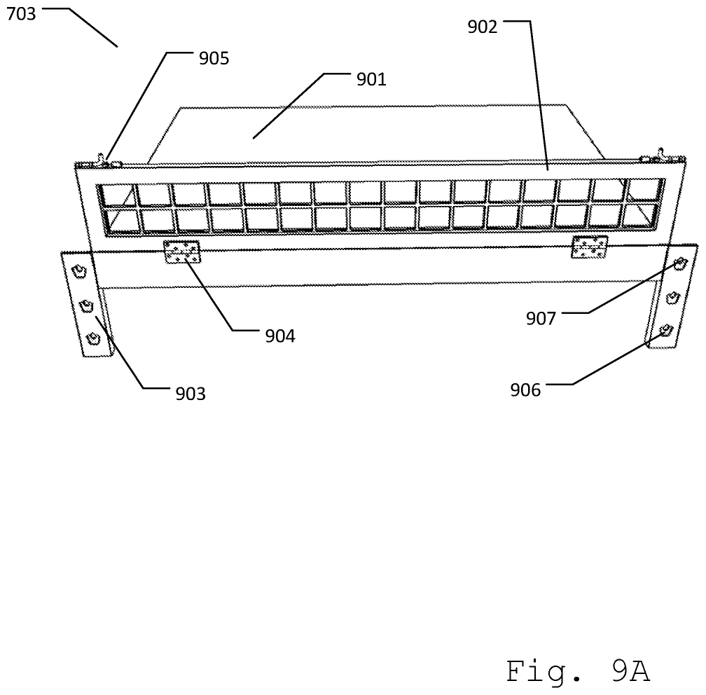

FIG. 7 illustrates an embodiment of a shelving unit 700. Shelving unit 700 can be a flexible display system capable of holding items 113. Thus, each item 113 stored within enclosure 101 can comprise RFID tag 114, which can be readable by RFID reader 111. In one embodiment, shelving unit 700 can be made of a non-ferrous material that allows electromagnetic signals to pass through. In one embodiment, shelving unit 700 can comprise vertical supports 701, one or more shelf assemblies 702, and one or more bases 703. Vertical supports 701 can, in one embodiment, be vertical bars placed at the four corners of shelving unit 700, while each shelf assembly 702 can be a horizontal surface that provides storage or display for items 113. In one embodiment, stand 703 can be placed at the bottom of each pair of bars 701. Bases 703 can ensure that shelving unit 700 is securely attached in place and can maintain an upright position within the shipping container. In one embodiment, stand 703 can attach shelving unit 700 to the bottom cross member of enclosure 101. In one embodiment, shelving unit 700 can further comprise a wall bracket 704. Wall bracket 704 can be a gridded sidewall that connects vertical supports 701 on common sides to each other. 701.

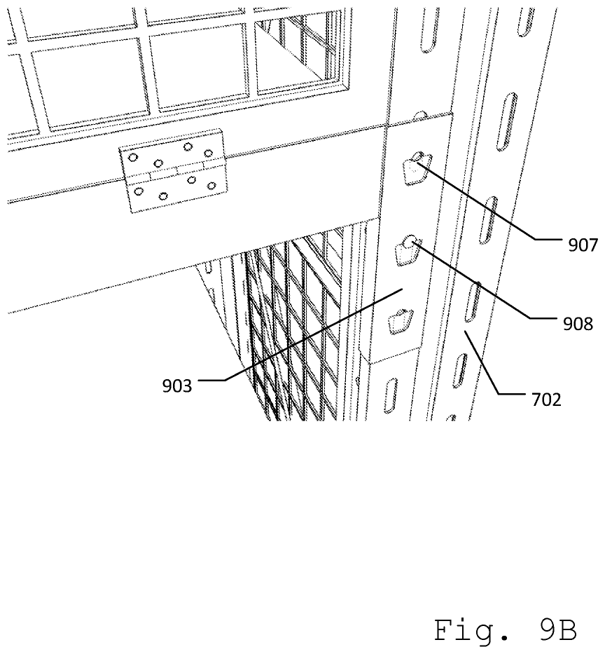

FIG. 8 illustrates a closer view of vertical support 701 comprising a plurality of slots 801, and a plurality of catches 802. Each slot 801 can be an opening that is uniformly distributed across the front surface of each vertical support 701 while catches 802 can be an opening that is uniformly distributed at the opposite side surfaces of each vertical support 701. In one embodiment, each catch 802 can be compatible with a latch fastener.

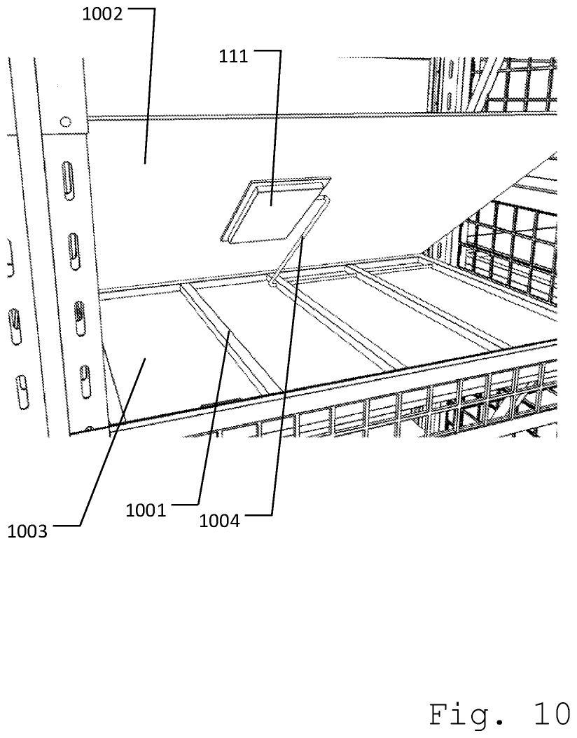

FIG. 9A illustrates an embodiment of shelf assembly 702 comprising a shelf base 901, a front guard 902, and a plurality of brackets 903. Shelf base 901 can be the portion of shelf assembly 702 that provides support to items 113. In one embodiment, front guard 902 can be a hinged railing attached to shelf base 901. In this embodiment, front guard 902 can comprise one or more hinges 904 and one or more latches 905. Hinges 904 can connect the bottom edge portion of front guard 902 the front side section of shelf base 901. Furthermore, hinges 904 can allow front guard 902 to be maneuverable into a locked position and an unlocked position. Latches 905 can keep front guard 902 in a locked position or an unlocked position, which can be further discussed below. In one embodiment, each bracket 903 can be an angular bar placed at the corners of shelf base 901. In such embodiment, bracket 903 placed on each side of shelf base 901 can be connectable to each pair of bars 701. In one embodiment, each bracket 903 can comprise one or more holes 906. Holes 906 can be aligned with slots 801 on bars 701. In this embodiment, shelf assembly 702 can attach to pair of bars 701 by attaching one or more fastening devices to holes 906 on bracket 903 with slots 801 on bars 701.

In another embodiment, each hole 906 can further comprise a notch 907. Notch 907 can be an extended hanging portion within each hole 906. In one embodiment, notch 907 can be slanted backwards. In this embodiment, notch 907 can be insertable within slots 801 of vertical support 701.

FIG. 9B illustrates how shelf assembly 702 can attach to vertical bars 701. In one embodiment, the exact vertical positioning of shelf assembly 702 within the pairs of vertical bars 701 can be adjustable. In such embodiment, shelf base 901 can rest on vertical bars 701 through brackets 903. In this embodiment, holes 906 on shelf base 901 can first be aligned with slots 801 of bars 701. Then, notches 907 on brackets 903 can be inserted within slots 801 of bars 701. This can allow shelf assembly 702 to be mounted and rest on each pair of bars 701. In another embodiment, one or more fastening devices 908 can be used to fasten brackets 903 with vertical bars 701. Fastening devices 908 can include but is not limited to screws, or nuts and bolts.

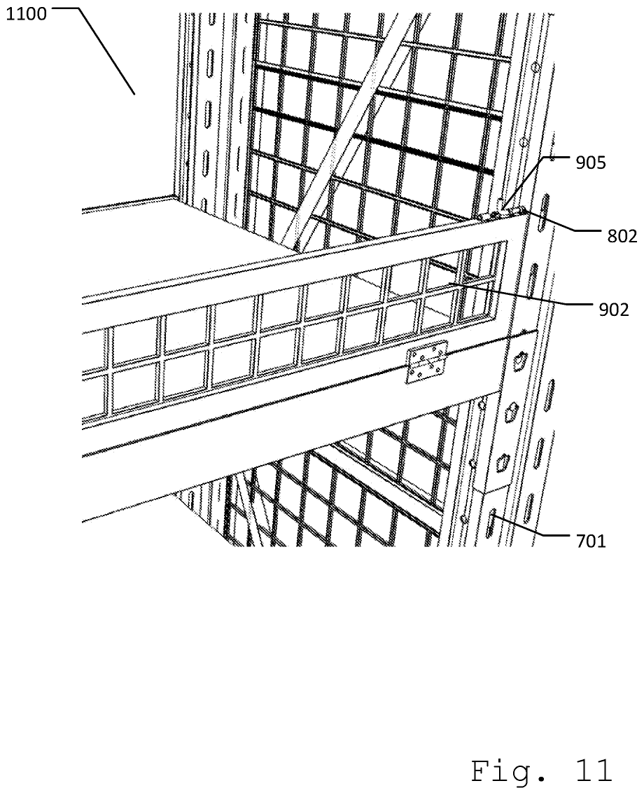

FIG. 10 illustrates shelf base 901 comprising an RFID reader 111. In one embodiment shelf base 901 can comprise a plurality of shelf beams 1001, a top platform 1002, and a bottom platform 1003. Shelf beams 1001 can be elongated beams placed in between top platform 1002 and bottom platform 1003. Shelf beams 1001 can provide support for top platform 1002. Top platform 1002 and bottom platform 1003 can be a flat sheet material that covers shelf beams 1001. In one embodiment, RFID reader 111 can be placed within shelf base 901. In such embodiment, RFID reader 111 can be placed in between top platform 1002 and bottom platform 1003. In this embodiment, RFID reader 111 can be positionable within the voids created between shelf beams 1001, top platform 1002, and bottom platform 1003. In one embodiment, RFID reader 111 can be mounted at the bottom of top platform 1002 while the cable coming out from RFID reader 111 can go through shelf beams 1001. This is to ensure that RFID reader 111 maintains its position within shelf base 901. For purposes of this disclosure, each shelf assembly 702 can comprise RFID reader 111. In such structure, RFID reader 111 can maintain contact with each items 113 by scanning and gathering information from RFID tag 114 attached to each item 113. As such, each shelf assembly 702 can comprise RFID reader 111 that can be connected to control system 110 via cable 1004.

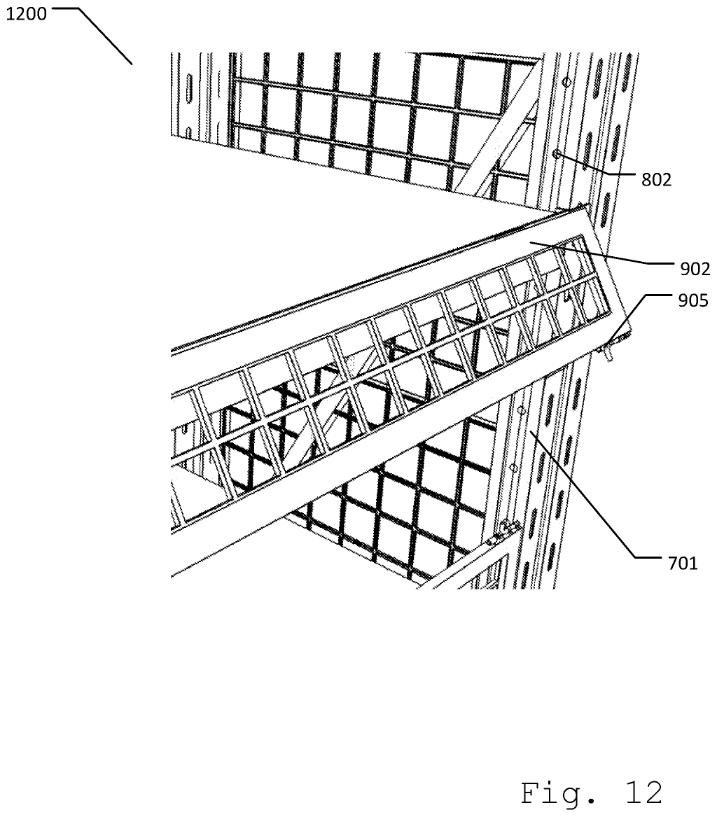

FIG. 11 illustrates an embodiment of front guard 902 at a locked position 1100. In one embodiment, latches 905 can be placed at the top edge of front guard 902. In locked position 1100, front guard 902 can be at an upright position such that front guard 902 can ensure that products within shelf assembly 702 are kept in place. In such position, latches 905 can be fastened to catch 802 of bars 701 to keep front guard 902 in locked position 1100.

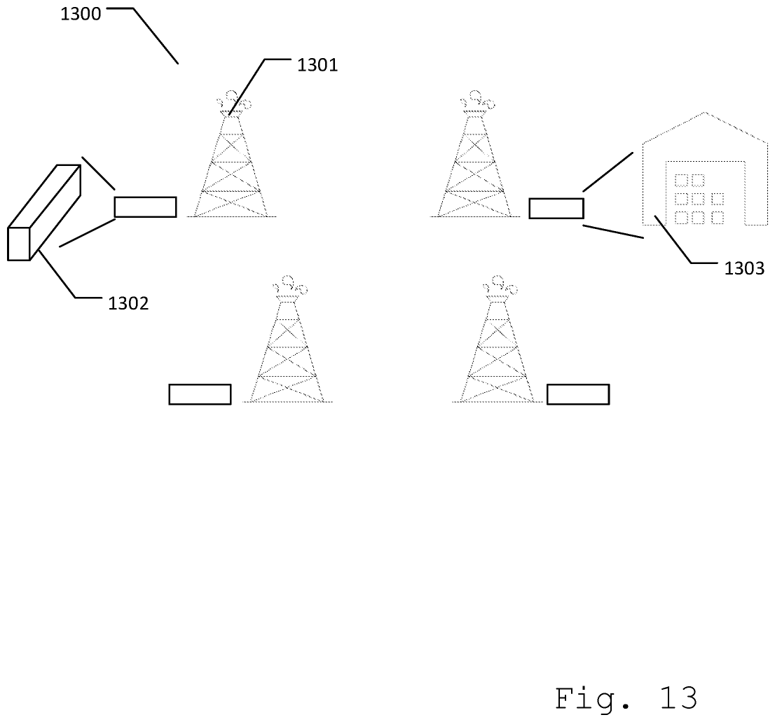

FIG. 12 illustrates an embodiment of front guard 902 at an unlocked position 1200. In such position, latch 905 can be unfastened from catch 802 allowing front guard 902 to hang downwards. In unlocked position 1200, the opening of shelf assembly 702 can be larger, which can allow easier access to items 113.

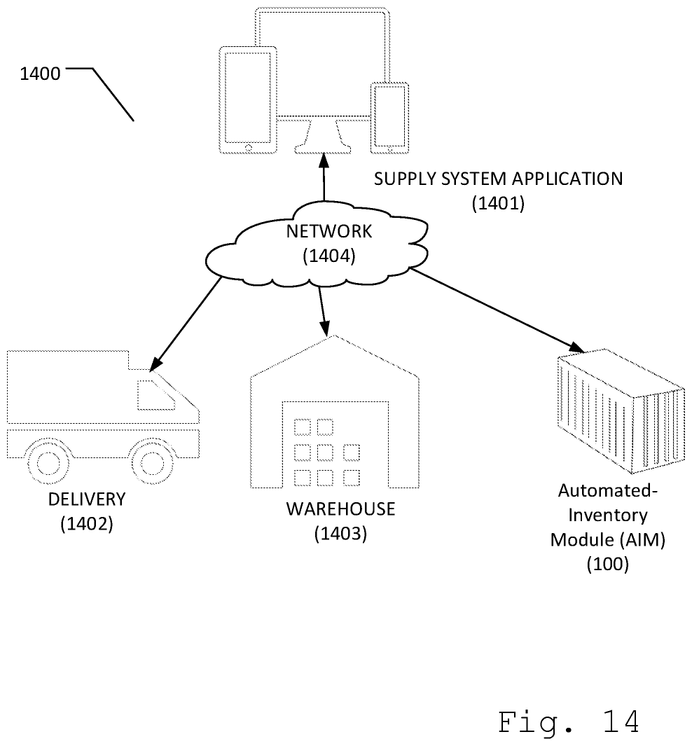

FIG. 13 illustrates a region 1300 comprising a plurality of worksites each with local storages such as a container 1302 or a warehouse 1303.

FIG. 14 illustrates an automated supply chain and e-commerce (ASCE) platform 1400. In this embodiment, ASCE platform 1400 can connect vendors with product consumers. In such embodiment, ASCE platform 1400 can comprise a supply system application 1401. Supply system application 1401 can be accessible via a website or mobile application. Supply system application 1401 can comprise business logic for a server. In one embodiment, supply system application 1401 can be configured to manage and monitor a supply chain. In such embodiment, one or more automated-inventory vehicle (AIV) system 1402, one or more automated-inventory warehouses (AIW) 1403, and one or more automated-inventory module (AIM) 100 can be interconnected through supply system application 1401. Supply system application 1401 can allow consumers and vendors to connect and know where inventory is in real time. In a preferred embodiment, vendors, consumers, or a third-party provider of the ASCE platform 1400 can set ordering parameters that ASCE platform can use to determine when to reorder inventory, what to order, and/or in what quantities. Examples of parameters can include a minimum quantity for a supply, a maximum quantity, delivery schedules, and approved supply lists. Network 1404 can be a local area network (LAN), a wide area network (WAN), a piconet, or a combination of LANs, WANs, or piconets. One illustrative LAN is a network within a single business. One illustrative WAN is the Internet. AIV system 1402 can allow vendors to monitor and manage supplies as supplies are moved from one location to another. AIW 1403 can be a warehouse wherein supplies are stored before being sold to a consumer or to a local storage such as AIM 100. AIW 1403 can also provide rapid fulfillment of orders since each product stored within the smart warehouse can be radio-frequency identification (RFID) controlled. As such, each item received, shipped, delivered, stored, etc. can be updated in the automated-inventory system in real-time. Thus, in one embodiment, AIW 1403 can have customizable inventory. AIM 100 can be used to store essential supplies or parts. In one embodiment, AIM 100 can be mobile, such that each AIM 100 can be picked up from one location and then be placed in another location. In such embodiment, each AIM 100 can be strategically placed near each work site 1301. In this embodiment, supply system application 1401 can connect with consumer's existing supply chain management and/or vendor's inventory platform. As such, supply system application 1401 can improve real-time inventory information, provide interconnected supply chain, provide real operational control, allow purchase orders automation, can reduce down time, and can improve vendor margins.

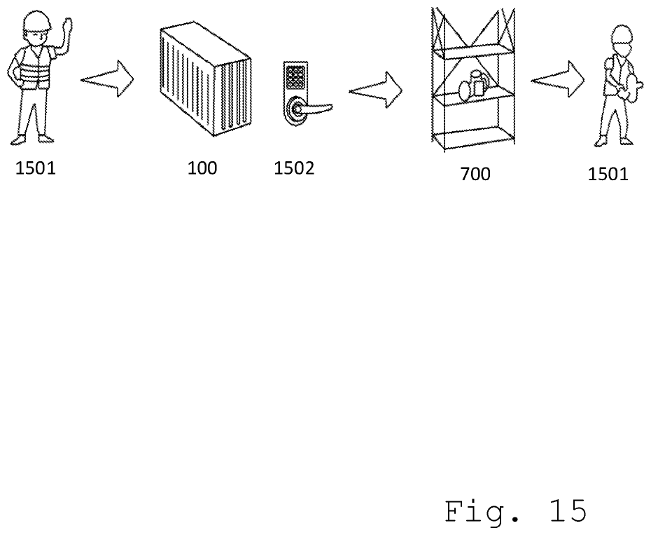

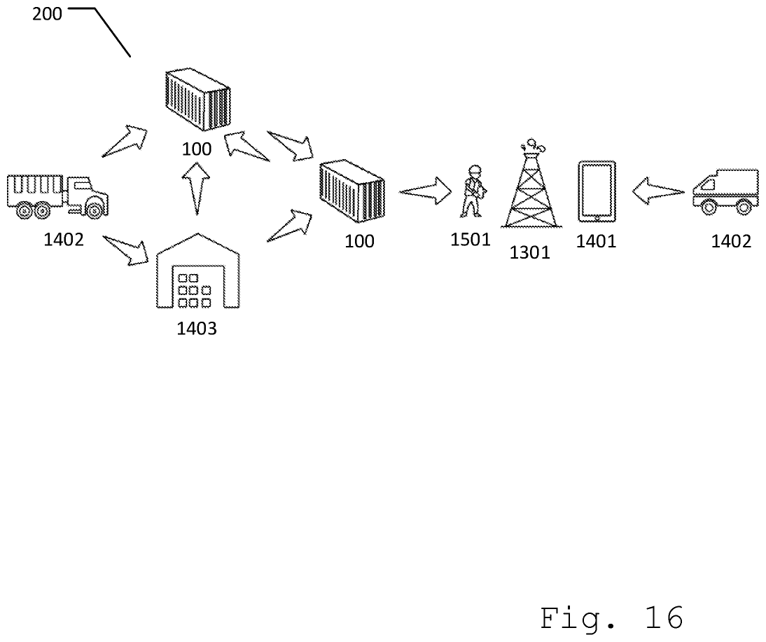

FIG. 15 illustrates an example embodiment of how a consumer 1501 can access one or more items 113 from AIM 100. Initially, consumer 1501 can access supply system application 1401 to determine whether item 113 is in AIM 100. If a item 113 is not in AIM 100, consumer 1501 can direct ASCE platform 1400 to move item 113 to AIM 100. Consumer can access AIM using an access key that provided to an access control 1502 of AIM 100. As such, consumer 1501 can enter AIM 100, grab the supply, and remove it from AIM 100. In this scenario, AIM 100 can be located near the contractor's drilling rig site 1301, which can lessen the non-productive time of going to and from a location to pick up items 113.

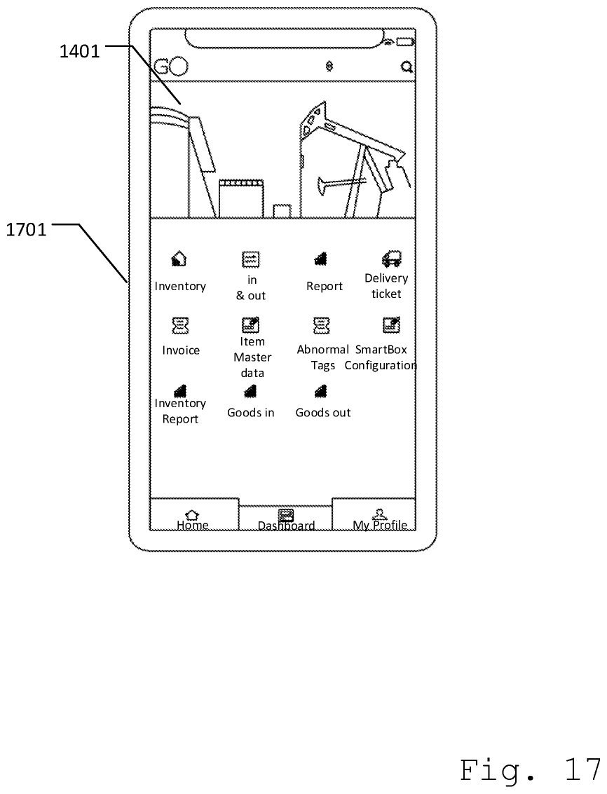

FIG. 16 illustrates how items 113 can be managed and monitored through ASCE platform 1400. In an example scenario, the vendor can provide consumers 1501 with items 113 that are commonly needed for work site 1301. In such scenario, items 113 can be stored in AIM 100, which can be continuously replenished by the vendor. In this scenario, inventory of items 113 that are placed within AIM 100 can also be recorded, monitored, and tracked. In one embodiment, AIM 100 can automatically register items 113 that consumer 1501 took out and can automatically register an order for the items that were took out through supply system application 1401. In such embodiment, AIM 100 can also record the quantity of items 113 that were took out. Orders can also be verified and monitored through supply system application 1401, such that expenditures can also be tracked. Further in another embodiment, when wrong parts are taken out from AIM 100, consumer 1501 can put it back and the automated-inventory module can register the item as returned in the supply system application. Parts replacement can also be handled through supply system application 1401. Further, in one embodiment, AIM 100 can be connected with AIW 1403. In such embodiment, AIW 1403 can have real time updates on supplies inventories of AIM 100. In such embodiments, vendors can know the needs of their customer's (contractor's 1501) in real-time. In case, wherein items 113 are low, vendors can replenish the parts needed by their customers in a timely manner. Moreover, vendors can receive notification when their own inventory are low and can prepare stocks for the next delivery run. AIM 100 can be strategically placed near drilling rig site 1301 for fast access. Once order is placed, consumer 1501 can pick up the orders as soon as access key 1502 is received from supply system application 1401. Thus, cutting large amount of time in waiting for orders and picking up orders from a warehouse. Furthermore, through ASCE platform 1400, vendors and consumers 1501 can have a real-time knowledge of items 113 that they have through supply system application 1401. In such embodiment, control system 110 can detect when item 113 is placed within enclosure 101, and can add the item 113 to an inventory list associated with enclosure 101 when the RFID tag associated with the item is detected within the enclosure by any of the one or more RFID readers 111. Control system 110 can also remove item 113 from the inventory list when the RFID tag associated with the item is no longer detected by any of the one or more RFID readers 111.

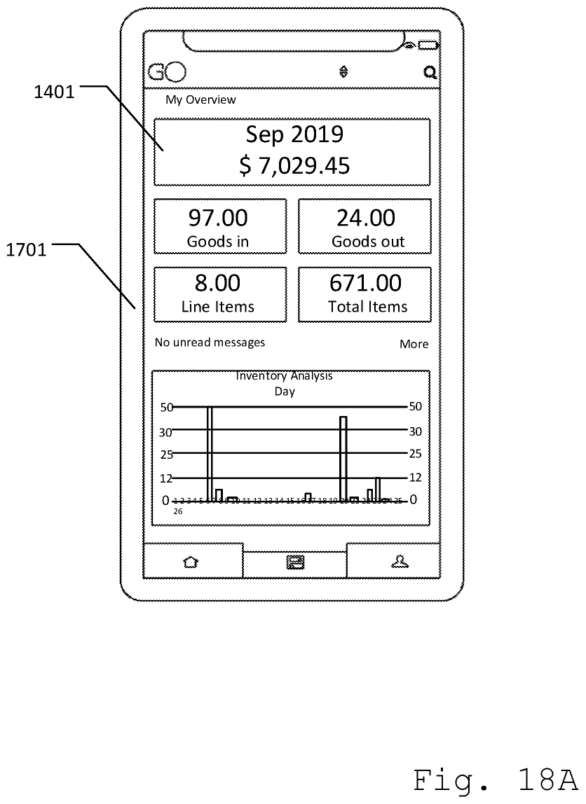

FIG. 17 illustrates a dashboard main screen embodiment of supply system application 1401. In this embodiment, supply system application 1401 can show relevant details of items 113 for both consumers 1501 and vendors. In one embodiment, supply system application 1401 can be accessible to both contractors and vendors through an electronic mobile device 1701. Electronic mobile device 1701 can be a desktop computer, laptop, tablet, personal digital assistant (PDA) or smart phone. In one embodiment, each consumer 1501 can register and create a user account on supply system application 1401 to be able to access the dashboard main screen. Similarly, each vendor will need to register and create a user account on supply system application 1401. In such embodiment, the dashboard and tools that can be accessible to the user can depend on the type of the user's account. As a non-limiting embodiment, a user can either have a contractor's account or a vendor's account, which can be further discussed below. In one example, users with contractor's account pick out parts of equipment from the pictures displayed on supply system application 1401, which can be more convenient for the users as they wouldn't have to remember the exact part numbers of the parts they needed. Such access may not be available or may be different from the users with vendor's account. In another example, vendors can manage item details, description, prices, etc. through online supply system application 1401. Such access can only be available to users with vendor's account.

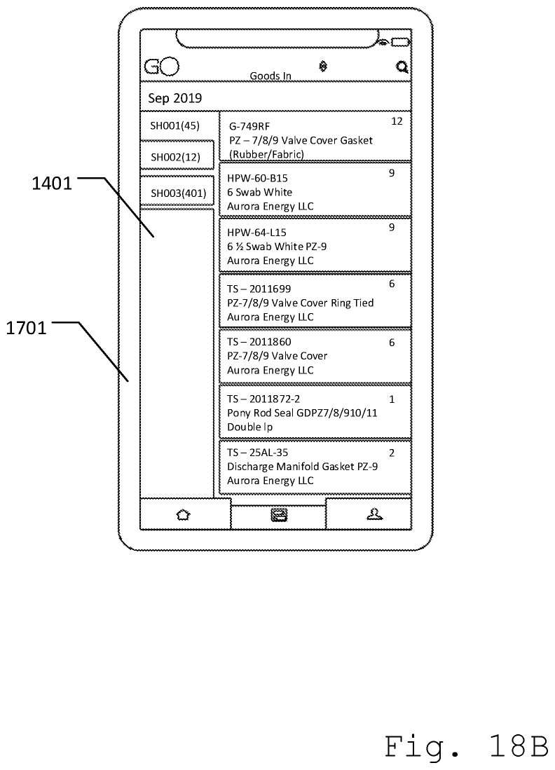

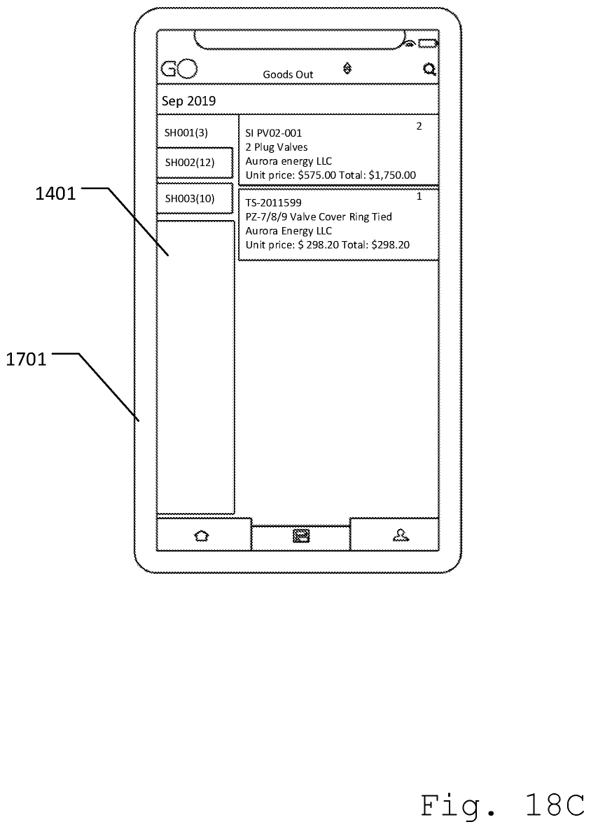

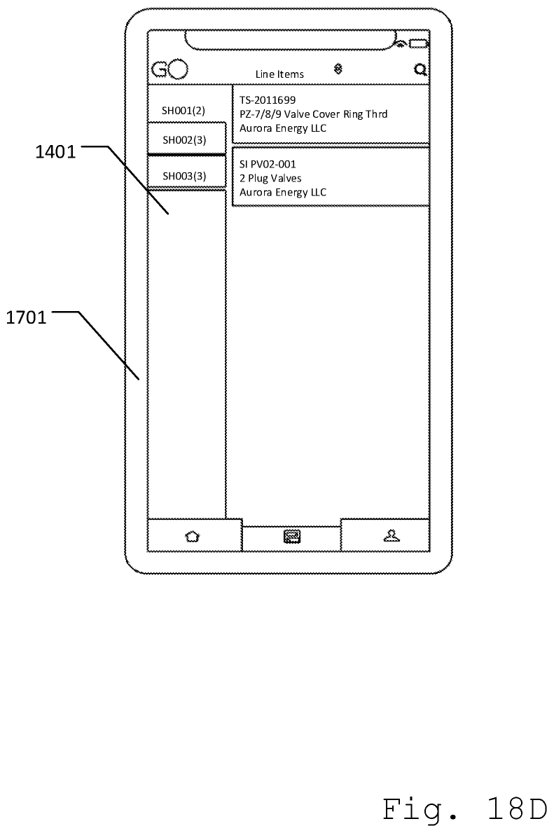

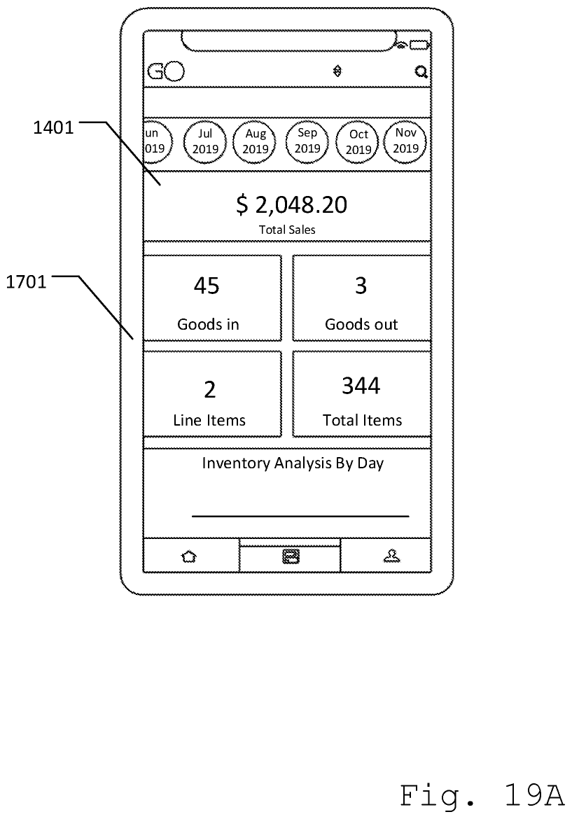

FIG. 18A-18D illustrates screen embodiments of supply system application 1401 as viewed by consumer 1501. In this embodiment, consumer 1501 can use his electronic mobile device 1701 to access a home page overview of supply system application 1401. In this embodiment, consumer 1501 can view details relevant to its user account such as amount of expenditure, list of goods in and goods out from AIM 100, current inventories, and, in some embodiments, parameters for automated ordering.

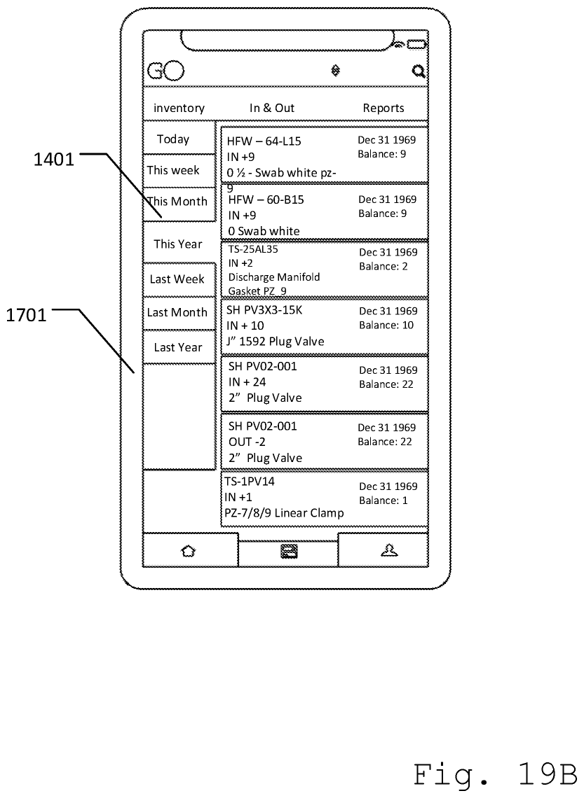

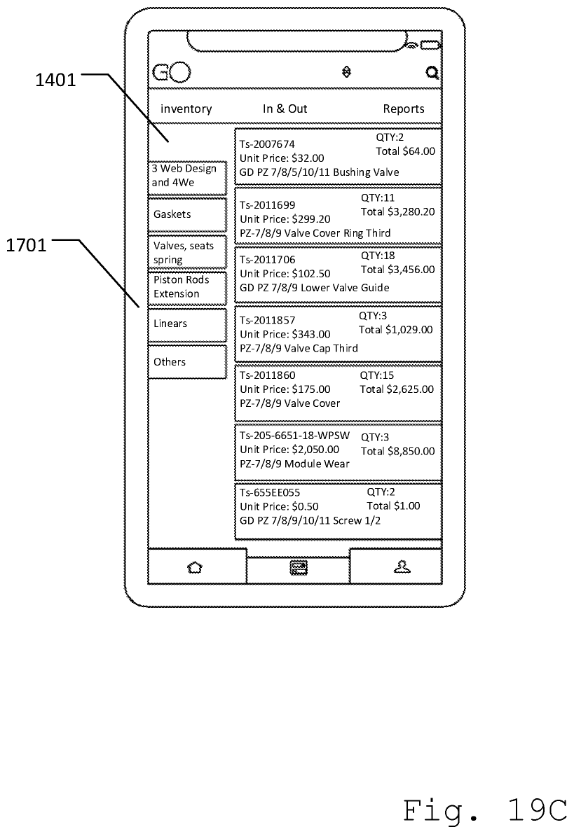

FIG. 19A-19C illustrates a screen embodiments of supply system application 1401 as viewed by vendors. In this embodiment, vendors can use his electronic mobile device 1701 to access supply system application 1401. In such embodiment, the vendor can view inventory report page, in and out of supplies (by week, month, year, etc.), and inventory report (by part or category) on supply system application 1401.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. An improved shelving unit for a shipping container comprising
one or more shelf assemblies, each of said one or more shelf assemblies comprising
a bottom platform,
a top platform, and
an RFID reader mounted between said bottom platform and said top platform, said top platform capable of supporting items,

2. The improved shelving unit of claim 1 wherein each of said one or more shelf assemblies comprises a plurality of beams that supports said top platform.

3. The improved shelving unit of claim 1 further comprising a plurality of vertical supports that support said one or more shelf assemblies.

4. The improved shelving unit of claim 3 wherein each of said one or more shelf assemblies comprises a front guard, said front guard comprising one or more latches, each of said latches capable of mating with catches of said vertical supports.

5. The improved shelving unit of claim 4 wherein each said front guard is maneuverable into
a locked position said front guard is in an upright position and capable of at least partially enclosing the items on said top platform; and
an unlocked position wherein said front guard can hang downward to allow less restrained access to place or remove items from top platform.

6. The improved shelving unit of claim 1 wherein said top platform is comprised of a non-ferrous material.

7. A method of using an improved shelving unit for a shipping container comprising the steps of
placing an item on a shelf assembly, each of said items tagged with an RFID tag, the shelf assembly comprising a bottom platform, a top platform, and an RFID reader mounted between said bottom platform and said top platform, said top platform capable of supporting said items, each of said shelf assemblies mounted to said one or more vertical support structures;
adding said item to an inventory when said RFID reader detects said RFID tag; and
removing said item from said inventory after FFID reader is no longer able to detect said RFID tag.

8. The method of claim 7 wherein the shelf assembly comprises a plurality of beams that supports said top platform.

9. The method of claim 7 further comprising a plurality of vertical supports that support said one or more shelf assemblies.

10. The method of claim 9 wherein each of said one or more shelf assemblies comprises a front guard, said front guard comprising one or more latches, each of said latches capable of mating with catches of said vertical supports.

11. The method of claim 10 wherein each said front guard is maneuverable into
a locked position said front guard is in an upright position and capable of at least partially enclosing the items on said top platform; and
an unlocked position wherein said front guard can hang downward to allow less restrained access to place or remove items from top platform.

12. The method of claim 7 wherein said top platform is comprised of a non-ferrous material.
